(19) United States
(12) Patent Application Publication
(10) Pub. No.: US 2026/0035502 A1
(43) Pub. Date: Feb. 5, 2026

(54) FLAME RETARDANT ACRYLIC POWDER COMPOSITION

(71) Applicant: Rohm and Haas Company, Collegeville, PA (US)

(72) Inventors: Pu Luo, King Of Prussia, PA (US); Ann E. Evans, Coatesville, PA (US)

(21) Appl. No.: 19/113,085

(22) PCT Filed: Sep. 26, 2023
(86) PCT No.: PCT/US2023/033650

§ 371 Date: Mar. 19, 2025

Related U.S. Application Data
(60) Provisional application No. 63/411,648, filed on Sep. 30, 2022.

(51) Int. Cl. C08F 297/02; C08L 69/00

(52) U.S. Cl. CPC C08F 297/026; C08L 69/00; C08L 2201/02; C08L 2205/035; C08L 2207/53

(57) ABSTRACT

A multistage acrylic composition comprises a first stage acrylic polymer and a final stage acrylic polymer formed on or around the first stage acrylic polymer. The final stage acrylic polymer comprises structural units of at least one organo-phosphorus monomer. The multistage acrylic composition is in the form of a powder.

### FIELD OF THE INVENTION

This invention relates generally to multistage acrylic polymer compositions that are useful as impact modifiers. The compositions contain an organo-phosphorus monomer in the final stage of the multistage acrylic polymer.

### BACKGROUND

Acrylic impact modifiers are often prepared in the form of a core-shell rubber (CSR) having a soft acrylic core covered with a harder, grafted shell. Core-shell rubber acrylic impact modifiers are typically prepared by conventional emulsion polymerization and isolated to powder.

Acrylic impact modifiers can be used in a variety of thermoplastics, including polycarbonate (PC).

There is a long-standing desire to introduce flame resistant moieties, molecules or atoms into acrylic impact modifiers. Such efforts, however, have met limited success due to the difficulties associated with incorporating such flame resistant moieties, molecules or atoms.

U.S. Pat. No. 11,254,990 discloses a composition comprising an aqueous dispersion of submicron-sized particles and micron-sized polymer beads, where one or both of the polymer particles or beads are functionalized with phosphorus acid groups. The compositions, however, are aqueous dispersions rather than a powder.

European Patent No. EP 2 235 077 B1 discloses a waterborne composition comprising an emulsion polymer composition containing a phosphorus-containing monomer.

U.S. Pat. No. 7,820,754 discloses an aqueous polymer composition obtained from a mix of monomers including at least one ethylenically unsaturated monomer carrying at least one second functionality selected from phosphate, phosphonate or phosphinate.

U.S. Pat. No. 7,803,858 discloses an aqueous composition comprising pigment particles, particles of acrylic polymer containing phosphate or phosphonate groups, and at least one compound containing a pyrophosphate linkage and having no more than 12% carbon.

Each of these prior art attempts provides an aqueous composition rather than a powder.

There is a desire to provide a flame retardant multistage acrylic composition in a powder form.

### SUMMARY OF THE INVENTION

One aspect of the invention provides a multistage acrylic composition comprising (a) a first stage polymer, wherein the first stage polymer comprises structural units of at least one organo-phosphorus monomer, and (b) a final stage polymer formed on or around the first stage acrylic polymer. The multistage acrylic composition is in the form of a powder.

In another aspect, the invention provides a matrix resin composition comprising (A) a multistage acrylic composition comprising (a) a first stage polymer, wherein the first stage polymer comprises structural units of at least one organo-phosphorus monomer, and (b) a final stage polymer formed on or around the first stage polymer, and (B) one or more matrix resins.

### BRIEF DESCRIPTION OF THE DRAWINGS

The FIGURE is a graph showing the total burn time after torch for polycarbonate formulations according to embodiments of the present invention.

### DETAILED DESCRIPTION

The inventors have surprisingly found that the incorporation of an organo-phosphorus monomer in the final stage of a multistage acrylic polymer can improve the flammability of acrylic polymers. Further, the inventors have found that the multistage acrylic polymer can be formed as a powder and provide desired impact resistance when used in a resin, such as polycarbonate.

As used herein, the term “polymer” refers to a polymeric compound prepared by polymerizing monomers, whether of the same or a different type. The generic term “polymer” includes the terms “homopolymer,” “copolymer,” “terpolymer,” and “resin.” As used herein, the term “structural unit” refers to the remnant of the recited monomer after polymerization. As used herein, the term “(meth)acrylate” refers to either acrylate or methacrylate or combinations thereof, and the term “(meth)acrylic” refers to either acrylic or methacrylic or combinations thereof. As used herein, the term “substituted” refers to having at least one attached chemical group, for example, alkyl group, alkenyl group, vinyl group, hydroxyl group, carboxylic acid group, other functional groups, and combinations thereof.

As used herein, the term “acrylic polymer” refers to a polymer wherein greater than 50 wt % of the structural units making up the polymer comprise (meth)acrylic acid monomers or (meth)acrylate monomers. Preferably, at least 60 wt % of the structural units of the acrylic polymer are (meth)acrylic acid monomers or (meth)acrylate monomers. More preferably, at least 70 wt % of the structural units of the acrylic polymer are (meth)acrylic acid monomers or (meth)acrylate monomers. Even more preferably, at least 80 wt % of the structural units of the acrylic polymer are (meth)acrylic acid monomers or (meth)acrylate monomers. Yet more preferably, at least 90 wt % of the structural units of the acrylic polymer are (meth)acrylic acid monomers or (meth)acrylate monomers.

As used herein, the term “organo-phosphorus” refers to organic compounds containing phosphorus. As used herein, the term “phosphate” refers to an anion that is made up of phosphorous and oxygen atoms. Included are orthophosphate (PO₄⁻³), the polyphosphates (PₙO₃ₙ₊₁⁻⁽ⁿ⁺²⁾ where n is 2 or larger), and the metaphosphates (circular anions with the formula PₘO₃ₘ^{-m} where m is 2 or larger). As used herein, an “alkaline phosphate” refers to a salt of an alkali metal cation with a phosphate anion. Alkaline phosphates include alkali metal orthophosphates, alkali metal polyphosphates, and alkali metal metaphosphates. Alkaline phosphates also include partially neutralized salts of phosphate acids, including, for example, partially neutralized salts of orthophosphoric acid such as, for example, monosodium dihydrogen phosphate and disodium hydrogen phosphate.

As used herein, the term “multistage polymer” refers to a polymer that is made by forming (i.e., polymerizing) a first polymer, called the “first stage” or the “first stage polymer,” and then, in the presence of the first stage, forming on or around the first stage a second polymer called the “second stage” or “second stage polymer,” which can be an intermediate stage or final stage. A multistage polymer has at least a first stage and a final stage, as well as optional intermediate stage formed between the first stage and the final stage. Each intermediate stage is formed in the presence of the polymer resulting from the polymerization of the stage immediately previous to that intermediate stage. In such embodiments wherein each subsequent stage forms a partial or complete shell around each of the particles remaining from the previous stage, the multistage polymer that results is known as a “core/shell” polymer, where the first stage polymer comprises the core and each subsequent stage comprises a shell on the preceding stage with the final stage forming the outermost shell.

As used herein, the term “weight average molecular weight” or “Mw” refers to the weight average molecular weight of a polymer as measured by gel permeation chromatography (“GPC”), for acrylic polymers against polystyrene calibration standards following ASTM D5296-11 (2011), and using tetrahydrofuran (“THF”) as the mobile phase and diluent. As used herein, the term “weight of polymer” means the dry weight of the polymer.

As used herein, the terms “glass transition temperature” or “T_{g}” refers to the temperature at or above which a glassy polymer will undergo segmental motion of the polymer chain. Glass transition temperatures of a copolymer can be estimated by the Fox equation (Bulletin of the American Physical Society, 1 (3) Page 123 (1956)) as follows:

$$1 / {T}_{g} = {w}_{1} / {T}_{g ( 1 )} + {w}_{2} / {T}_{g ( 2 )}$$

For a copolymer, w₁ and w₂ refer to the weight fraction of the two comonomers, and T_{g(1)} and T_{g(2)} refer to the glass transition temperatures of the two corresponding homopolymers made from the monomers. For polymers containing three or more monomers, additional terms are added (wₙ/T_{g(n)}). The glass transition temperatures of the homopolymers may be found, for example, in the “Polymer Handbook,” edited by J. Brandrup and E. H. Immergut, Interscience Publishers. The T_{g} of a polymer can also be measured by various techniques, including, for example, differential scanning calorimetry (“DSC”). As used herein, the phrase “calculated T_{g}” shall mean the glass transition temperature as calculated by the Fox equation. When the T_{g} of a multistage polymer is measured, more than one T_{g} may be observed. The T_{g} observed for one stage of a multistage polymer may be the same as the T_{g} that is characteristic of the polymer that forms that stage (i.e., the T_{g} that would be observed if the polymer that forms that stage were formed and measured in isolation from the other stages). When a monomer is said to have a certain T_{g}, it is meant that a homopolymer made from that monomer has that T_{g}.

As used herein, when it is stated that “the polymer composition contains little or no” of a certain substance, it is meant that the polymer composition contains none of that substance, or, if any of that substance is present in the present composition, the amount of that substance is 1% or less by weight, based on the weight of the polymer composition. Among embodiments that are described herein as having “little or no” of a certain substance, embodiments are envisioned in which there is none of that certain substance.

The polymer composition of the present invention contains a multistage acrylic polymer made by aqueous emulsion polymerization. In aqueous emulsion polymerization, water forms the continuous medium in which polymerization takes place. The water may or may not be mixed with one or more additional compounds that are miscible with water or that are dissolved in the water. The continuous medium may contain 30 weight % or more water, or 50 weight % or more water, or 75 weight % or more water, or 90 weight % or more water, based on the weight of the continuous medium.

Emulsion polymerization involves the presence of one or more initiator. An initiator is a compound that forms one or more free radical, which can initiate a polymerization process. The initiator is usually water-soluble. Some suitable initiators form one or more free radical when heated. Some suitable initiators are oxidants and form one or more free radical when mixed with one or more reductant, or when heated, or a combination thereof. Some suitable initiators form one or more free radical when exposed to radiation such as, for example, ultraviolet radiation or electron beam radiation. A combination of suitable initiators is also suitable.

Preferably, the multistage acrylic polymer is made by emulsion polymerization to form a latex. The latex preferably has a mean particle size of 50 nm or higher, or 100 nm or higher. The latex preferably has a mean particle size of less than 1 micrometer, or less than 800 nm, or less than 600 nm.

The emulsion polymerization may optionally use at least one organo-phosphorus soap comprising an anionic phosphate surfactant. Each anionic phosphate surfactant has a cation associated with it forming an alkaline metal salt of the phosphate surfactant including, for example, alkyl phosphate salts and alkyl aryl phosphate salts. Suitable cations include, for example, ammonium, cation of an alkali metal, and mixtures thereof. Suitable alkaline metal salts of the phosphate surfactant include, for example, polyoxyalkylene alkyl phenyl ether phosphate salt, polyoxyalkylene alkyl ether phosphate salt, polyoxyethylene alkyl phenyl ether phosphate salt, and polyoxyethylene alkyl ether phosphate salt. The alkaline metal salt of the phosphate surfactant may comprise a polyoxyethylene alkyl ether phosphate salt. The weight of the phosphate surfactant present in emulsion polymerization of the multistage polymer may range from, for example, 0.5 wt % or more, preferably 1.0 wt % or more, and more preferably 1.5 wt % or more, as characterized by weight of phosphate surfactant based on the total monomer weight added to the polymerization. The weight of the phosphate surfactant when present in emulsion polymerization of the multistage acrylic polymer may range from, for example, 5 wt % or less, preferably 4 wt % or less, and more preferably 3 wt % or less, as characterized by weight of phosphate surfactant based on the total monomer weight added to the polymerization. One or more anionic surfactants in addition to the anionic phosphate surfactant described above may be utilized in the emulsion polymerization. Suitable additional anionic surfactants include, for example, carboxylates, sulfosuccinates, sulfonates, and sulfates.

The multistage acrylic polymer of the present invention contains a first stage acrylic polymer and a final stage acrylic polymer formed on or around the first stage acrylic polymer, wherein the final stage acrylic polymer contains structural units of at least one organo-phosphorus monomer.

As used herein, the term “organo-phosphorus monomer” refers to a phosphorus-containing monomer. The organo-phosphorus monomer may be in the acid form or as a salt of the phosphorus acid groups. Examples of organo-phosphorus monomers include:

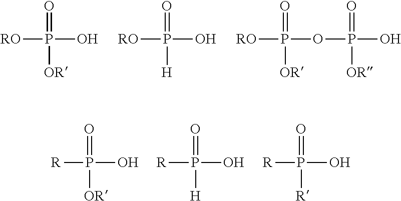

where R is an organic group containing an acryloxy, methacryloxy, or a vinyl group, and R′ and R″ are independently selected from H and a second organic group. The second organic group may be saturated or unsaturated. Suitable organo-phosphorus monomers include dihydrogen phosphate-functional monomers such as dihydrogen phosphate esters of an alcohol in which the alcohol also contains a polymerizable vinyl or olefinic group, such as allyl phosphate, mono- or diphosphate of bis(hydroxy-methyl) fumarate or itaconate, derivatives of (meth)acrylic acid esters, such as, for examples phosphates of hydroxyalkyl (meth)acrylates including 2-hydroxyethyl (meth)acrylate, 3-hydroxypropyl (meth)acrylates, and the like.

Other suitable organo-phosphorous monomers include CH₂═C(R)—C(O)—O—(R′O)ₙ—P(O)(OH)₂, where R═H or —CH₃, R′=alkyl, and n=1 to 5, such as the methacrylates SIPOMER™ PAM-100, SIPOMER™ PAM-200, SIPOMER™ PAM-400, SIPOMER™ PAM-600 and the acrylate, SIPOMER™ PAM-300, available from Solvay.

Other suitable organo-phosphorus monomers are phosphonate functional monomers, disclosed in WO 99/25780 A1, and include vinyl phosphonic acid, allyl phosphonic acid, 2-acrylamido-2-methylpropanephosphonic acid, α-phosphonostyrene, 2-methylacrylamido-2-methylpropanephosphonic acid. Further suitable organo-phosphorus monomers are 1,2-ethylenically unsaturated (hydroxy)phosphinylalkyl (meth)acrylate monomers, disclosed in U.S. Pat. No. 4,733,005, and include (hydroxy)phosphinylmethyl methacrylate.

Preferably, the organo-phosphorus monomers comprise at least one compound of formula CH₂═C(R)—C(O)—O—(R′O)ₙ—P(O)(OH)₂. More preferably, R is —CH₃, R′ is an alkyl group comprising 1 to 6 carbon atoms, and n=1.

The final stage may contain structural units of at least one organo-phosphorus monomer in an amount of 0.25 weight % or more, or 0.5 weight % or more, based on the total weight of the final stage acrylic polymer. The final stage may contain polymerized units derived from the at least one organo-phosphorus monomer in an amount of 5 weight % or less, 4 weight % or less, 3 weight % or less, 2.5 weight % or less, or 2.0 weight % or less, based on the total weight of the final stage acrylic polymer. Preferably, the final stage contains structural units of the at least one organo-phosphorus monomer in an amount ranging from 0.25 to less than 5 weight % based on total weight of the final stage acrylic polymer. More preferably, the final stage contains structural units of the at least one organo-phosphorus monomer in an amount ranging from 0.5 to 3 weight % based on the total weight of the final stage.

The final stage acrylic polymer further comprises structural units of one or more substituted or unsubstituted (meth)acrylate monomers. Preferably, the final stage acrylic polymer comprises structural units of at least one aryl (meth)acrylate or alkyl (meth)acrylate monomers, wherein the alkyl of the alkyl (meth)acrylate monomers is selected from linear and branched alkyl groups with 1 to 12 carbon atoms. Preferably, the final stage acrylic polymer comprises structural units of one or more monomers selected from butyl acrylate, ethyl hexyl acrylate, ethyl acrylate, methyl methacrylate, butyl methacrylate, cyclohexyl (meth)acrylate, cyclopentyl methacrylate, tetrahydrofuryl methacrylate, and benzyl (meth)acrylate. More preferably, the final stage acrylic polymer comprises structural units of methyl methacrylate.

The final stage acrylic polymer may further comprise structural units of one or more substituted or unsubstituted styrene. Suitable substituted styrenes include, for example, alpha-alkyl styrenes (e.g., alpha-methyl styrene). When present, the structural units of one or more substituted or unsubstituted styrene may comprise up to 40 wt % of the total weight of the final stage acrylic polymer. For example, the structural units of one or more substituted or unsubstituted styrene may comprise 5 wt %, 10 wt %, 20 wt %, 30 wt %, or 40 wt % of the total weight of the final stage acrylic polymer.

The final stage polymer may have a T_{g} of 50° C. or more, or 90° C. or more. The final stage polymer may have a T_{g} of 200° C. or less, or 150° C. or less. Preferably, the final stage polymer contains polymerized units derived from monomers having a T_{g} of 50° C. or higher in an amount of 50 wt % or higher, or 75 wt % or higher, or 90 wt % or higher based on the total weight of the final stage polymer.

The multistage polymer may contain the final stage polymer, for example, in an amount of 2 weight % or more, or 10 weight % or more, or 20 weight % or more, based on the total weight of the multistage polymer. The multistage polymer may contain the final stage polymer, for example, in an amount of 50 weight % or less, or 25 weight % or less, or 10 weight % or less, based on the total weight of the multistage polymer.

The final stage is formed on or around the first stage acrylic polymer, either directly on or around the first stage acrylic polymer or indirectly by forming the final stage on an intermediate stage. Preferably, the final stage acrylic polymer is grafted to the first stage acrylic polymer via a graft-linker used to form the first stage acrylic polymer.

The first stage acrylic polymer comprises structural units of one or more substituted or unsubstituted (meth)acrylate monomers. Preferably, the first stage polymer comprises structural units of one or more alkyl (meth)acrylate monomers, wherein the alkyl of the alkyl (meth)acrylate monomers is selected from linear and branched alkyl groups with 1 to 12 carbon atoms. More preferably, the first stage comprises structural units of at least one monomer selected from butyl acrylate, ethyl hexyl acrylate (e.g., 2-ethyl hexyl acrylate), ethyl acrylate, methyl methacrylate, butyl methacrylate, and iso-octylacrylate. Even more preferably, the first stage comprises structural units of at least one monomer selected from butyl acrylate and ethyl hexyl acrylate.

The first stage acrylic polymer may be polymerized in the presence of a cross-linking or graft-linking monomer. Examples of cross-linking and/or graft-linking monomers useful in the first stage acrylic polymer include but are not limited to butanediol diacrylate, butanediol dimethacrylate, ethylene glycol diacrylate, ethylene glycol dimethacrylate, divinyl benzene, diethylene glycol diacrylate, diethylene glycol dimethacrylate, diallyl maleate, allyl methacrylate, diallyl phthalate, triallyl phthalate, trimethylolpropane triacrylate. Preferably, the first stage acrylic polymer comprises structural units of allyl methacrylate. When present, the first stage polymer may comprises structural units of a cross-linking or graft-linking monomer in an amount of 0.1 to 10 weight % based on the total weight of the first stage acrylic polymer. Preferably, the first stage polymer comprises structural units of a cross-linking or graft-linking monomer in an amount of 0.2 to 5 weight % based on the total weight of the first stage acrylic polymer.

Preferably, the first stage polymer has a T_{g} of 40° C. or less, 20° C. or less, 0° C. or less, −20° C. or less, or −35° C. or less, or −50° C. or less. The first stage polymer preferably has a T_{g} of −150° C. or more, or −100° C. or more.

The multistage polymer may contain the first stage polymer, for example, in an amount of 70 wt % or more, or 80 wt % or more, or 90 wt % or more, based on the total weight of the multistage polymer. The multistage polymer may contain the first stage polymer in an amount of 98 wt % or less, or 95 wt % or less, based on the total weight of the multistage polymer.

The first stage acrylic polymer may further comprise polymerized units derived from at least one organo-phosphorus monomer. The at least one organo-phosphorus monomer of the first stage acrylic polymer may be the same as or different than the at least one organo-phosphorus monomer of the final stage polymer. Preferably, the at least one organo-phosphorus monomer of the first stage acrylic polymer and the at least one organo-phosphorus monomer of the final stage acrylic polymer are the same. Without wishing to be bound by theory, it is believed that incorporating an organo-phosphorus monomer in both the first stage acrylic polymer and the final stage acrylic polymer may further improve flammability.

When present, the polymerized units derived from the at least one organo-phosphorus monomer in the first stage acrylic monomer may be present in an amount of 0.25 weight % or more, or 0.5 weight % or more, based on the total weight of the first stage polymer. The first stage may contain polymerized units derived from the at least one organo-phosphorus monomer in an amount of 5 weight % or less, 4 weight % or less, 3 weight % or less, 2 weight % or less, or 1 weight % or less, based on the total weight of the first stage polymer.

The weight ratio of the first stage polymer to the final stage polymer may range, for example, from 0.1:1 or higher, or 0.2:1 or higher, or 0.4:1 or higher, or 1:1 or higher, or 1.5:1 or higher, or 3:1 or higher, or 4:1 or higher. The weight ratio of the first stage polymer to the final stage polymer may range, for example, from 50:1 or lower, or 25:1 or lower, or 20:1 or lower.

The multistage polymer may contain one or more intermediate stage polymers. The total sum of the intermediate stage polymers may be present in an amount of 1 weight % or more, or 2 weight % or more, or 5 weight % or more, or 10 weight % or more, based on the total weight of the multistage polymer. The total sum of the intermediate stage polymers may be present in an amount of 60 weight % or less, or 2 weight % or less, or 5 weight % or less, or 10 weight % or less, based on the total weight of the multistage polymer. Like the final stage polymer in the multistage polymer, the one or more intermediate stage polymers may also comprise polymerized units derived from one or more organo-phosphorus monomers.

In the process of the present invention, the multistage polymer latex is isolated by coagulation or spray drying to form a powder. Preferably, the multistage polymer latex is isolated by coagulation.

When present, the organo-phosphorus soap may be retained on the surface of the multistage polymer when coagulated. Suitable methods of coagulation include, for example, coagulation with a divalent cation.

Suitable divalent cations include, for example, divalent metal cations and alkaline earth cations. Suitable divalent cations include, for example, calcium (+2), cobalt (+2), copper (+2), iron (+2), magnesium (+2), zinc (+2), and mixtures thereof. Preferably, the multivalent cations are selected from calcium (+2), and magnesium (+2). More preferably, every divalent cation that is present is calcium (+2), or magnesium (+2), or a mixture thereof. Even more preferably, the divalent cation comprises calcium (+2). The divalent cation may be present, for example, in an amount of 10 ppm or more, or 30 ppm or more, or 100 ppm or more, by weight based on the dry weight of multistage polymer. The divalent cation may be present, for example, in an amount of 3 weight % or less, or 1 weight % or less, or 0.3 weight % or less, based on the dry weight of the multistage polymer.

Preferably, most or all of the divalent cation that is present in the composition is in the form of a water insoluble phosphate salt. The molar amount of divalent cation that is present in the form of a water insoluble phosphate salt may be, for example, 80% or more, or 90% or more, or 95% or more, or 98% or more, or 100%, based on the total moles of divalent cation present in the composition.

Preferably, most or all of the water that remains with the isolated polymer is removed from the isolated polymer by one or more of the following operations: filtration (including, for example, vacuum filtration), and/or centrifugation. The isolated polymer may be optionally washed with water one or more times. Coagulated polymer is a complex structure, and it is known that water cannot readily contact every portion of the coagulated polymer. While not wishing to be bound by theory, it is contemplated that a significant amount of divalent cation and residual organo-phosphorus soap will be left behind. Accordingly, the composition of the present invention may contain organo-phosphorus soap in an amount of 50 ppm or more, or 100 ppm or more, or 500 ppm or more, based on the dry weight of the multistage polymer. The composition of the present invention may contain organo-phosphorus soap in an amount of 10,000 ppm or less, or 7,500 ppm or less, or 5,000 ppm or less, based on the dry weight of the multistage polymer.

Preferably, the dried multistage polymer has a water content of less than 1.0 weight % based on the weight of the dried multistage polymer.

The polymer composition of the present invention may also include a stabilizer. Suitable stabilizers include, for example, radical scavengers, peroxide decomposers, and metal deactivators. Suitable radical scavengers include, for example, hindered phenols (e.g., those having a tertiary butyl group attached to each carbon atom of the aromatic ring that is adjacent to the carbon atom to which a hydroxyl group is attached), secondary aromatic amines, hindered amines, hydroxylamines, and benzofuranones. Suitable peroxide decomposers include, for example, organic sulfides (e.g., divalent sulfur compounds, e.g., esters of thiodopropionic acid), esters of phosphorous acid (H₃PO₃), and hydroxyl amines. Suitable metal deactivators include, for example, chelating agents (e.g., ethylenediaminetetraacetic acid).

As noted above, one aspect of the present invention utilizes the polymer composition described herein as an impact modifier in a matrix resin composition containing the multistage polymer composition and a matrix resin. After the mixture of multistage acrylic polymer powder and matrix resin is mixed and melted and formed into a solid item, the impact resistance of that item will be better than the same solid item made with matrix resin that has not been mixed with multistage polymer. The multistage polymer may be provided in a solid form, e.g., pellets or powder or a mixture thereof. The matrix resin may also be provided in solid form, e.g., pellets or powder or a mixture thereof. Solid multistage acrylic polymer powder may be mixed with solid matrix resin, either at room temperature (20° C.) or at elevated temperature (e.g., 30° C. to 90° C.). Alternatively, solid multistage acrylic polymer powder may be mixed with melted matrix resin, e.g., in an extruder or other melt mixer. Solid multistage acrylic polymer powder may also be mixed with solid matrix resin, and the mixture of solids may then heated sufficiently to melt the matrix resin, and the mixture may be further mixed, e.g., in an extruder or other melt-processing device.

The weight ratio of the matrix resin to the multistage acrylic polymer powder of the present invention may range for example, from 1:1 or higher, or 1.1:1 or higher, or 2.3:1 or higher, or 4:1 or higher, or 9:1 or higher, or 19:1 or higher, or 49:1 or higher, or 99:1 or higher.

Suitable matrix resins include, for example, polyolefins, polystyrene, styrene copolymers, poly(vinyl chloride), poly(vinyl acetate), acrylic polymers, polyethers, polyesters, polycarbonates, polyurethanes, and polyamides. Preferably, the matrix resin contains at least one polycarbonate. Suitable polycarbonates include, for example homopolymers of polymerized units derived from Bisphenol A (“BPA”), and also copolymers that include polymerized units of BPA along with one or more other polymerized units.

The matrix resin may contain at least one polyester. Suitable polyesters include, for example, polyethylene terephthalate and polybutylene terephthalate.

The matrix resin may contain a blend of polymers. Suitable blends of polymers include, for example, blends of polycarbonates and styrene resins, and blends of polycarbonates and polyesters. Suitable styrene resins include, for example, polystyrene and copolymers of styrene with other monomers, e.g., acrylonitrile/butadiene/styrene (“ABS”) resins.

The matrix resin composition containing multistage acrylic polymer and matrix resin may contain one or more additional materials that are added to the mixture. Any one or more of such additional materials may be added to the multistage polymer or to the matrix resin prior to formation of the final mixture of all materials. Each of the additional materials (if any are used) may be added (alone or in combination with each other and/or in combination with multistage polymer) to matrix resin when matrix resin is in solid form or in melt form. Suitable additional materials include, for example, dyes, colorants, pigments, carbon black, fillers, fibers, lubricants (e.g., montan wax), flame retardants (e.g., borates, antimony trioxide, or molybdates), and other impact modifiers that are not multistage polymers of the present invention.

The matrix resin composition may be used to form a useful article, for example by film blowing, profile extrusion, molding, other methods, or a combination thereof. Molding methods include, for example, blow molding, injection molding, compression molding, other molding methods, and combinations thereof.

The multistage polymer of the present invention may provide significant improvements in the flammability of the matrix resin composition.

Some embodiments of the invention will now be described in detail in the following Examples.

### EXAMPLES

### Preparation of Multistage Acrylic Polymer

To a 5 liter, 4-necked round bottomed flask equipped with a mechanical stirrer, thermometer, condenser, and electric heating mantle, was charged 1873 g of deionized water, 1.5 g Tetrasodium pyrophosphate and 0.2 g of Alkyldiphenyloxide disulfonate. The reactor contents were sparged with nitrogen and heated to 45° C. with agitation. In a separate container, 91 g Butyl Acrylate, 30 g 2-Ethyl hexyl acrylate and 1 g of Allyl methacrylate were mixed. The monomer mixture was then added to the kettle as a shot. This was immediately followed by 0.3 g tert-Butyl hydroperoxide and 0.25 g sodium formaldehyde sulfoxylate. The reaction contents were held until the reaction exotherm was complete, after which the reaction contents were brought to 50° C. and a mixture consisting of 91 g Butyl Acrylate, 30 g 2-Ethyl hexyl acrylate and 1 g of Allyl methacrylate were added, followed by 0.1 g tert-Butyl hydroperoxide and 0.1 g sodium formaldehyde sulfoxylate. The reaction contents were held until the reaction exotherm was complete and then 2.0 g of Alkyldiphenyloxide disulfonate were added to the reactor after which the reaction contents were brought to 50° C. again. Then a mixture consisting of 327 g Butyl Acrylate, 109 g 2-Ethyl hexyl acrylate and 3 g of Allyl methacrylate were added, followed by 0.3 g tert-Butyl hydroperoxide and 0.3 g sodium formaldehyde sulfoxylate. The reaction contents were held until the reaction exotherm was complete and then 4.0 g of Alkyldiphenyloxide disulfonate were added to the reactor and the reaction contents were brought to 50° C. again. Then a mixture consisting of 327 g Butyl Acrylate, 109 g 2-Ethyl hexyl acrylate and 3 g of Allyl methacrylate were added, followed by 0.3 g tert-Butyl hydroperoxide and 0.3 g sodium formaldehyde sulfoxylate. The reaction contents were held until the reaction exotherm was complete and then a redox pair consisting of 0.1 g tert-Butyl hydroperoxide and 0.1 g sodium formaldehyde sulfoxylate were added, followed by 1.3 g of Alkyldiphenyloxide disulfonate and a hold of 20 minutes duration. The reaction contents were brought to 50° C. again and then 97 g Methyl methacrylate were added to the reactor, followed by 0.3 g tert-Butyl hydroperoxide and 0.3 g sodium formaldehyde sulfoxylate. After the exotherm was completed, the reaction contents were held for 10 minutes. After the hold, the batch was cooled to 40° C. before pack out when the emulsion was characterized and found to have a particle size of 308 nm and solids of 34.9%.

For the examples in which the phosphate monomer (SIPOMER™ PAM-600, phosphoethyl methacrylate) was added to the core, half of the charge was used in each of the 3^{rd} and 4^{th} monomer mix additions and the Alkyldiphenyloxide disulfonate was replaced on an actives basis with organophosphorous soap. In examples where the phosphate monomer was added to the shell, the charge replaced a corresponding amount of Methyl methacrylate.

The control sample (Comparative Example 1) and samples of the invention (Examples 1 to 4) were prepared using the compositions according to Table 1 below, where the values are provided by weight % of the monomers in the first stage acrylic polymer.

### Coagulation of Multistage Acrylic Polymer

### Antioxidant Emulsion Preparation

To a 250 ml plastic container were added 1.5 g of Dowfax 2A1 (25%), 12.7 g of Irganox 1076 and 70.9 g deionized water. The mixture was heated to 60° C. and homogenized at 10,000 rpm for 5 minutes.

### Emulsion Preparation

To a 1 Liter bottle was added 481.6 g of emulsion (CP7605—“1st Comparative Example”, EXL-2390 control) diluted to 30% TS with 85.1 g deionized Water and heated to 51° C. in a water bath. Once at target temperature to the diluted emulsion 34.2 g of the antioxidant emulsion listed above was added and mixed thoroughly. The emulsion was stored at 51° C. until ready for Coagulation.

### Coagulation

To a 3-liter beaker were added 4.76 g of Calcium Chloride powder and 1133.3 g deionized water. The beaker contents were heated to 51° C. under agitation at 350 rpm. When the contents reached 51° C., the preheated emulsion above was added slowly over 45-60 seconds to the beaker. This caused phase separation of the mixture into a water phase and a solid polymer phase. 79.3 g of a 10% Calcium Chloride aqueous solution was added to complete the coagulation. One minute later 30.6 g of K-120 (diluted to 10% TS) was added slowly to the beaker. The mixture was then heated to 81° C. and held at 81° C. for 30 minutes. After the hold, the mixture was cooled, dewatered, and washed in a Büchner funnel. The samples were washed with deionized water until the filtrate conductivity is below 30 μS/m, and then dewatered. After dewatering the resulting wetcake was treated with a phosphate spray. The phosphate spray was comprised of 0.9 g 6% solution of Monosodium Phosphate and 7.43 g 20% solution of Disodium Phosphate. The samples were dried in a vacuum oven for overnight at 65° C. The particle size of the powder is measured on a Malvern Mastersizer 2000.

In other examples the process above was modified to incorporate the additional components added.

### Table 1

| | Compar- | | | | |
|---|---|---|---|---|---|
| | ative | | | | |
| | Example | Example | Example | Example | Example |
| | 1 | 1 | 2 | 3 | 4 |
| | (wt %) | (wt %) | (wt %) | (wt %) | (wt %) |
| First | | | | | |
| stage: | | | | | |
| Butyl | 74.5 | 74.5 | 74.5 | 72.5 | 72.5 |
| Acrylate | | | | | |
| 2-Ethyl | 24.8 | 24.8 | 24.8 | 24.8 | 24.8 |
| Hexyl | | | | | |
| Acrylate | | | | | |
| Allyl | 0.7 | 0.7 | 0.7 | 0.7 | 0.7 |
| Methacrylate | | | | | |
| PAM-600 | 0 | 0 | 0 | 2 | 2 |
| Final | | | | | |
| Stage: | | | | | |
| Methyl | 100 | 98 | 98 | 98 | 98 |
| Methacrylate | | | | | |
| PAM-600 | 0 | 2 | 2 | 2 | 2 |

### Comparative Example 2

### Preparation of Comparative Polymer Composition M732

The multistage acrylic polymer powders of the present invention were compared to a commercially available impact modifier having flame retardant properties, product name M-732 manufactured by Kaneka Corporation. The rubber component of M-732 is core/shell type methacrylate-butadiene-styrene (MBS) copolymer.

### Polycarbonate Formulation

Polycarbonate formulations were prepared with the multistage acrylic polymer powder (AIM) of Comparative Example 1 and Examples 1 to 3, and the M732 powder (MBS) of Comparative Example 2. The formulations in accordance with Table 1 were compounded in an extruder to create pellets for injection molding.

TABLE 2

| Formulation | Description | Loading level |
|---|---|---|
| PC (LEXAN 141) | MFI 10 g/10 min | Up to 100% |
| MBS/AIM | Impact modifier | 2.5% |
| Perfluoro Sulfonate | Flame Retardant | 0.1% |
| Anti-dripping Agent | PTFE 50% MB | 0.50% |
| Irganox 1076 | BASF AO | 0.10% |
| Irgafos 168 | BASF AO | 0.10% |

PC Lexan 141: Polycarbonate from SABIC
AIM/MBS: AIM powder of Examples 1-4 and Comparative Example 1 or M732 powder of Comparative Example 2
FR-2025a: 100% potassium perfluorobutane sulfonate from 3M
IRGANOX ® 1076 and IRGANOX ® 168: anti-oxidants from BASF

The polycarbonate formulations were injection molded to form double end-gated 1.5 mm ASTM burn bars for flammability testing using the UL 94 flammability test method. The injection molding conditions are shown below in Table 3.

TABLE 3

| Barrel Temperature | | |
|---|---|---|
| (Zone 1, 2, 3, 4, Nozzle) | ° F. | 525 straight profile |
| Mold Temperature | ° F. | 120 |
| Hold Time | s | 6 |
| Hold Pressure | psi | 17500 |
| Cooling Time | s | 18 |
| Back Pressure | psi | 1000 |
| Screw Speed | rpm | 25 |
| Injection Speed | cc/s | 65 |
| Cushion | cc | 11 |
| Transfer | cc | 13 |
| Shot Size | cc | 36 |
| Suck Back | cc | 1 |

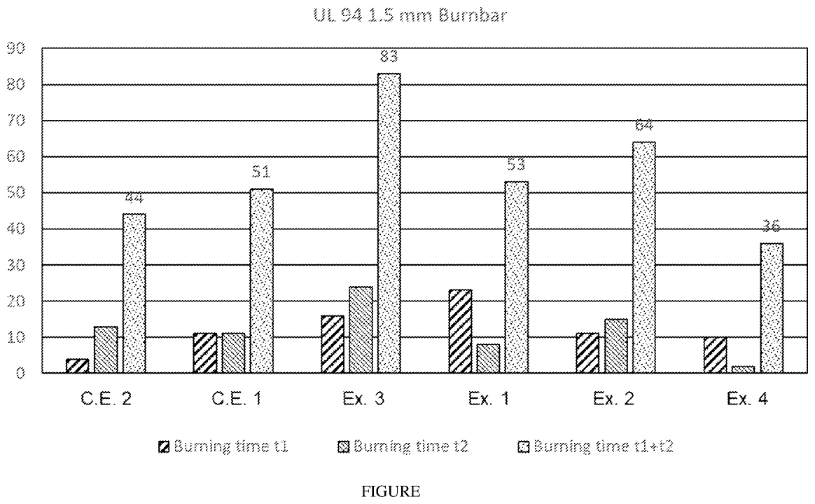

The results of the UL 94 test are shown in the graph of FIG. 1, which shows the total burn time after torch for 5 bars. As can be seen in the graph in FIG. 1, the multistage acrylic powder formulations of Examples 1-4 performed well on the UL 94 test, with each sample scoring a V-1 rating or better. Example 4 scored a V-0 rating for flammability in the UL 94 test, which is an improvement on Comparative Example 1 and had significantly better t2 and t1+t2 burning times compared to Comparative Example 2.

Notched Izod Impact Results are shown in Table 4 below. As seen in Table 4, the impact strength of the inventive examples demonstrated an improvement over the Comparative Example 2.

TABLE 4

| | | | | | Particle |
|---|---|---|---|---|---|
| | | | | | Size |
| | | Impact Strength [Ft-lbf/in] | | | Synthesis |
| Sample ID | UL | −20° C. | 0° C. | RT | (nm) |
| Comparative Example 1 | V-1 | 11.37 | 14.41 | 15.95 | 308 |
| Example 1 | V-1 | 8.30 | 14.46 | 14.74 | 168 |
| Example 2 | V-1 | 9.92 | 14.66 | 14.86 | 124 |
| Example 3 | V-1 | 2.58 | 3.3 | 13.27 | 190 |
| Example 4 | V-0 | 2.40 | 3.33 | 14.40 | 240 |
| Comparative Example 2 | V-0 | 2.73 | 5.14 | 13.23 | — |

What is claimed is:

1. A multistage acrylic composition comprising:
(a) a first stage acrylic polymer, and
(b) a final stage acrylic polymer formed on or around the first stage acrylic polymer,
wherein the final stage acrylic polymer comprises structural units of at least one organo-phosphorus monomer;
wherein the multistage acrylic composition is in the form of a powder.

2. The composition of claim 1, wherein the first stage polymer further comprises structural units of one or more alkyl (meth)acrylate monomers, wherein the alkyl of the alkyl (meth)acrylate monomers is selected from linear and branched alkyl groups with 1 to 12 carbon atoms.

3. The composition of claim 2, wherein the first stage polymer comprises structural units of at least one monomer selected from butyl acrylate, ethyl hexyl acrylate, ethyl acrylate, methyl methacrylate, butyl methacrylate, and iso-octylacrylate.

4. The composition of claim 1, wherein the first stage polymer further comprises structural units of at least one monomer selected from butanediol diacrylate, butanediol dimethacrylate, ethylene glycol diacrylate, ethylene glycol dimethacrylate, divinyl benzene, diethylene glycol diacrylate, diethylene glycol dimethacrylate, diallyl maleate, allyl methacrylate, diallyl phthalate, triallyl phthalate, trimethylolpropane triacrylate.

5. The composition of any one of the preceding claims, wherein the first stage polymer further comprises structural units of at least one organo-phosphorus monomer in the first stage acrylic polymer may be the same or different as the at least one organo-phosphorus monomer in the first stage acrylic polymer.

6. The composition of claim 1, wherein the at least one organo-phosphorus monomer in the final stage acrylic polymer is a compound of formula CH₂═C(R)—C(O)—O—(R′O)ₙ—P(O)(OH)₂, wherein R is H or —CH₃, R′ is an alkyl and n ranges from 1 to 5.

7. The composition of claim 6, wherein R is —CH₃ and R′ is an alkyl group comprising 1 to 6 carbon atoms.

8. The composition of claim 1, wherein the final stage acrylic polymer further comprises structural units of one or more aryl (meth)acrylate or alkyl (meth)acrylate monomers, wherein the alkyl of the alkyl (meth)acrylate monomers is selected from linear and branched alkyl groups with 1 to 12 carbon atoms.

9. The composition of claim 8, wherein the final stage acrylic polymer comprises structural units of one or more monomers selected from butyl acrylate, ethyl hexyl acrylate, ethyl acrylate, methyl methacrylate, butyl methacrylate, cyclohexyl (meth)acrylate, cyclopentyl methacrylate, tetrahydrofuryl methacrylate, and benzyl (meth)acrylate.

10. The composition of claim 1, wherein the first stage polymer is present in an amount of from 70 to 98 weight %, based on the total weight of the multistage polymer, and the final stage polymer is present in an amount of from 2 to 30 weight %, based on the total weight of the multistage polymer.

11. The composition of claim 1, wherein the at least one organo-phosphorus monomer is present in the final stage polymer in an amount less than 5 wt % based on the total weight of the final stage polymer.

12. The composition of claim 11, wherein the at least one organo-phosphorus monomer is present in the final stage acrylic polymer in an amount less than 3 wt % based on the total weight of the final stage acrylic polymer.

13. The composition of claim 1, further comprising at least one organo-phosphorus soap in an amount of 50 ppm or more, based on the dry weight of the multistage polymer, wherein the organo-phosphorus soap comprises one or more of polyoxyalkylene alkyl phenyl ether phosphate salt, polyoxyalkylene alkyl ether phosphate salt, polyoxyethylene alkyl phenyl ether phosphate salt, and polyoxyethylene alkyl ether phosphate salt.

14. A matrix resin composition comprising mixing one or more matrix resins and the composition of claim 1.

15. The matrix resin composition of claim 14, wherein the matrix resin is selected from the group consisting of one or more polycarbonate, one or more polycarbonate blended with one or more polyester, and one or more polycarbonate blended with one or more ABS resin.
